(19) United States
(12) Patent Application Publication
(10) Pub. No.: US 2004/0004630 A1
(43) Pub. Date: Jan. 8, 2004

(54) Interactive audio-visual system with visual remote control unit

(76) Inventors: Hari Kalva, South Orange, NJ (US); Anthony Vetro, Short Hills, NJ (US)

Correspondence Address: Patent Department, Mitsubishi Electric Research Laboratories, Inc., 201 Broadway, Cambridge, MA, 02139, US

(21) Appl. No.: 10/189,988

(22) Filed: Jul. 4, 2002

(51) Int. Cl. G09G 5/00

(52) U.S. Cl. 345/702; 345/719

(57) ABSTRACT

An audio-visual system includes a receiver and a remote control unit linked by a radio frequency wireless link. The receiver receives displays a primary television signal having a first format. The primary television signal is then transcoded to a secondary television signal having a second format compatible with the remote control unit. The remote control unit receives and displays the secondary television signal on a touch-sensitive display that can be used to operate the receiver.

### FIELD OF THE INVENTION

This invention relates generally to the field of audio-visual systems, and more particularly to remote control units used with audio-visual systems.

### BACKGROUND OF THE INVENTION

Audio-visual (AV) systems are fairly common and available in the market today. Some of these AV systems have interactive digital television capabilities. Interactive AV systems enable a user to interactively engage with the AV content. These interactive AV systems use a remote control unit (RCU) and menus displayed on a television screen to enable the user to interact with the content.

FIG. 1 shows the components of a typical prior art AV system 100. A digital AV receiver 300 receives a television signal 101 by satellite, terrestrial, or cable means. The digital AV receiver 300 decodes the television signal 101, and renders the content on an output device, such as a television screen 120. The television screen 120 can be a cathode ray tube, a projector, or a LCD. A remote control unit 200 can control the AV receiver 300 using remote control functions 201, such as channel selection, volume adjustment, and receiver setup. The remote control unit 200 is also used to navigate the AV program by pressing buttons on the remote control unit. Typically, the RCU communicates with receiver via an infra-red (IR) transmitter 142 and an IR receiver 141. FIG. 2 shows the remote control functions 200 in greater detail. The RCU includes a processor 210 to execute functions such as volume control 211, channel selection 212, and menu control 213. Usually, a keypad 220 is used for entering commands. An encoder 230 encodes the commands for the IR transmitter 142. The AV receiver 300 decodes and acts on the commands. Current program information such as the name and number of the selected channel, and current time and date information can be displayed on the television screen 120. In addition, the television screen 120 is used to display menus and data entry fields for configuring the receiver 300.

FIG. 3 shows the prior art digital AV receiver 300 in greater detail. The digital AV receiver 300 receives the signals 101 by the cable, satellite, or terrestrial means. A tuner 310 is used to select a specific frequency that corresponds to a specific television channel. The tuner 310 is responsive to user commands decoded by a remote input processor 320, e.g., selected channels. The selected channel is demodulated 330 to recover the digital AV program data that is transmitted by a means such as the MPEG-2 transport stream.

An MPEG-2 demultiplexer 340 partitions the transport stream into audio and video signals, and any interactive TV commands. An audio decoder 351 provides an audio signal for an amplifier 361 connected to audio output means 371, e.g., loudspeakers. Similarly, a video decoder 352 provides a signal for a display and graphics processor 362. The processor 362 can combine the video output from the decoder 352 with any optional graphical elements, such as interactive TV menus, sub titles, and AV receiver setup menu obtained from the ITV command processor 353. The composite video is then rendered to a display device, such as the television screen 120 of FIG. 1. The remote input processor 320 also processes other commands, such as volume control, and interactive TV commands.

U.S. Pat. No. 6,351,270 issued to Nishikawa et al., on Feb. 26, 2002 describes an AV system for displaying a graphical menu and a “decimated” video on a television screen to that a user can navigate through available content.

U.S. Pat. No. 5,767,919 issued to Lee et al., on Jun. 16, 1998 describes a remote control unit for displaying and processing graphical menus displayed on a television screen.

To interact with content delivered to a television, most interfaces use of a graphical overlay on the television screen to allow users to interact with the content and to alert users to the presence of interactive content on the television. U.S. Pat. No. 6,335,736 issued to Wagner et al. on Jan. 1, 2002 describes one such system.

Some systems allow dynamically changing the user interface based on certain characteristics, see U.S. Pat. No. 6,292,187 issued to Gibbs et al. on Sep. 18, 2001.

U.S. Pat. No. 6,144,003 issued to Chor et al., on Oct. 31, 2000 describes a graphical user interface that includes a channel bar and icon for selecting available channels.

Some digital AV systems combine audio with the visual user interface to prompt users when particular options are available. U.S. Pat. No. 6,388,715 issued to Eggen et al., on May 24, 2002 describes an electronic program guide that produces an audio signal that is characteristic of a particular program category when that program category is selected.

U.S. Pat. No. 6,313,887 issued to Gudorf et al., on Nov. 6, 2001 describes a pager that can receive and display paging information, e.g., program schedules, broadcast by a pager service provider.

The prior art systems primarily use the keypad on the remote control unit to make content selections and navigate the graphical menu displayed on the television screen. User input is typically provided by selecting highlighted portions on the television screen followed by clicking the appropriate buttons on the remote control unit. The user cannot randomly select an option. Navigation among available options is done by sequentially “scanning” through the options. The disadvantage is that the user has to rely on the graphical menu on the television in order to activate a selection button on the remote control unit. Another disadvantage is that the user has to be near the television to see the display and operate the remote control unit due to the limited line-of-sight range of IR transceivers.

Therefore, there is a need for an audio-visual system that overcomes the problems of prior-art systems.

### SUMMARY OF THE INVENTION

The present invention provides a remote control unit (RCU) for an audiovisual (AV) receiver, with a secondary display, which is based on the primary display seen on a television screen. The secondary display includes a touch-sensitive surface for entering commands corresponding to interactive display elements. In addition, communication between the AV receiver and the RCU uses radio signals which do not need to be line-of-sight.

The digital AV receiver is equipped with an encoder to generate a secondary television signal from the primary television signal. The RCU decodes the secondary television signal and renders the decoded signal on a touch-sensitive display screen. The AV receiver and the RCU are equipped with a wireless communication means with sufficient bandwidth to carry the transcoded signals from the AV receiver to the RCU, as well as, user commands the RCU to the AV receiver.

### BRIEF DESCRIPTION OF THE DRAWING

FIG. 1 is a block diagram of a prior art digital AV receiver and remote control unit;

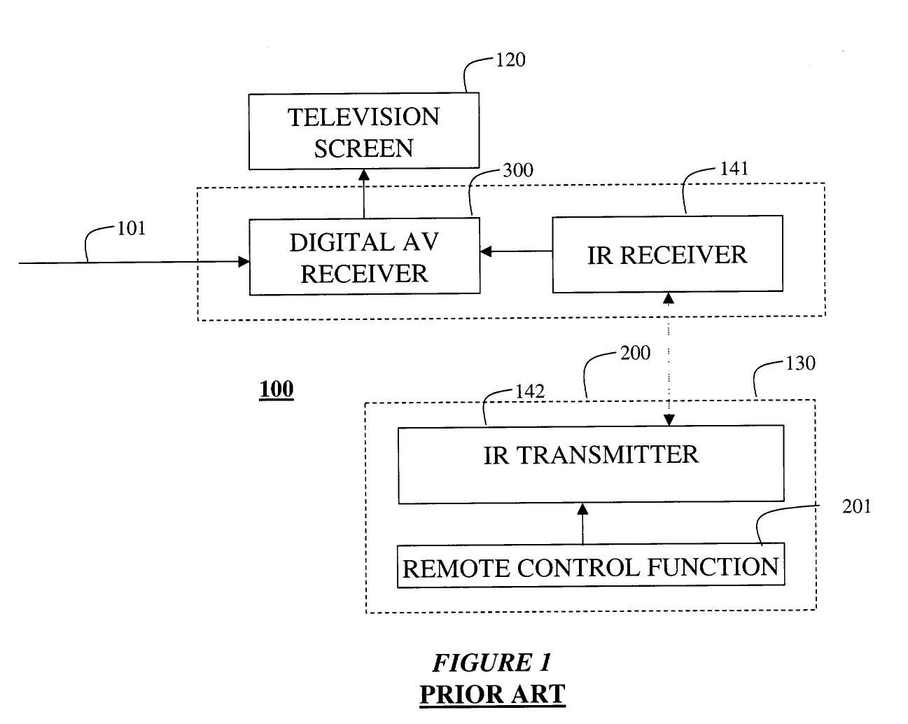

FIG. 2 is a block diagram of a prior art remote control unit;

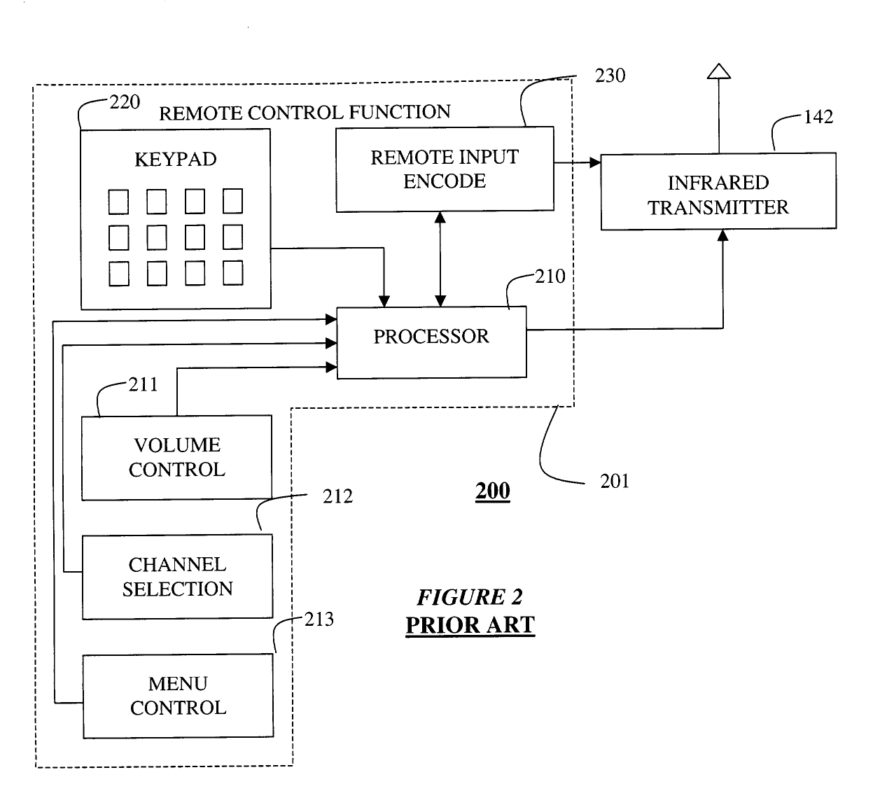

FIG. 3 is a block diagram of a prior art AV receiver;

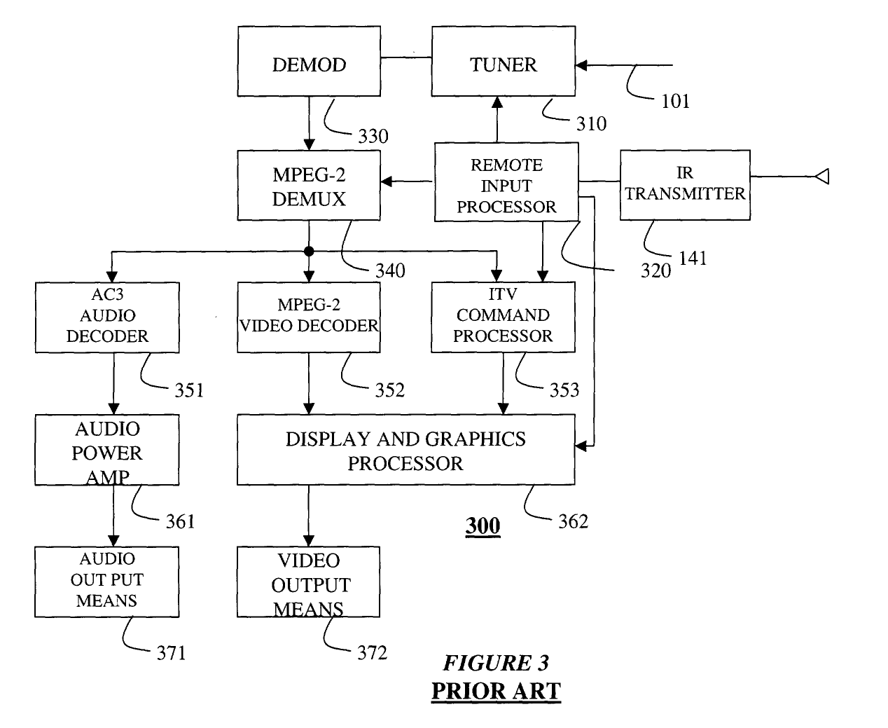

FIG. 4 is a block diagram of an AV receiver and remote control unit according to the invention;

FIG. 5 is a block diagram of the remote control unit according to the invention;

FIG. 6 is a block diagram of the AV receiver according to the invention; and

FIG. 7a-c depict application scenarios according to the invention.

### DETAILED DESCRIPTION OF PREFERRED EMBODIMENTS

System Overview

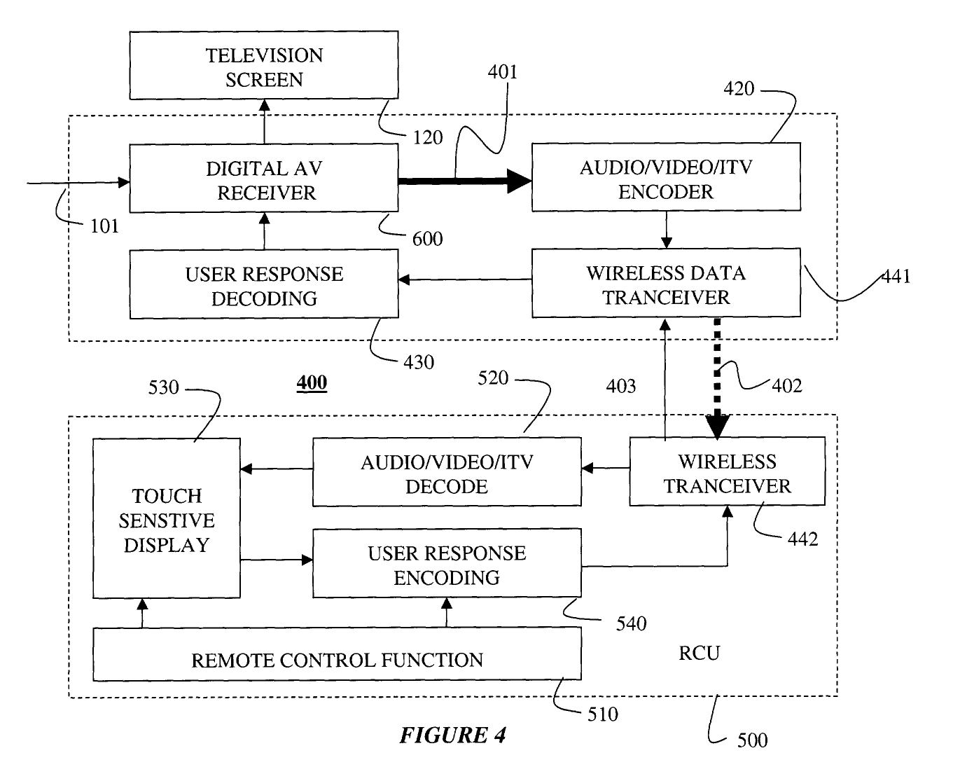

FIG. 4 shows an AV system 400 according to the invention. The system 400 receives a television (TV) signal 101 by cable, satellite, or terrestrial means. An AV receiver 600 decodes the TV signal for display on a television screen 120.

Primary to Secondary TV Signal Transcoding

The receiver 600 also provides input to an audio/video/ITV encoder 420. We call this the primary TV signal 401. The format of the primary TV signal is essentially as is seen on the television screen 120. The encoder 420 encodes the primary TV signal 401 to a secondary TV signal 402 having a format suitable for decoding and display on a RCU 500, as described in greater detail below. We call the conversion of the primary to the secondary TV signal “transcoding.”

A first wireless transceiver 441 has sufficient bandwidth to transmit the encoded secondary TV signal 402 to a second wireless transceiver 442 of the RCU 500. The wireless transceivers 441-442 are also used to transfer commands, such as channel selection, volume control and interactive commands, from the RCU 500 to the AV receiver 600. The commands are generated by a remote control function 510 of the RCU 500. The RCU 500 also includes a decoder 520, and a touch sensitive display 530. The user response decoding block 430 decodes the RCU commands for further processing by the receiver 600. The commands are encoded 540 in the RCU 500 before transmitted to the receiver 600.

Remote Control Unit

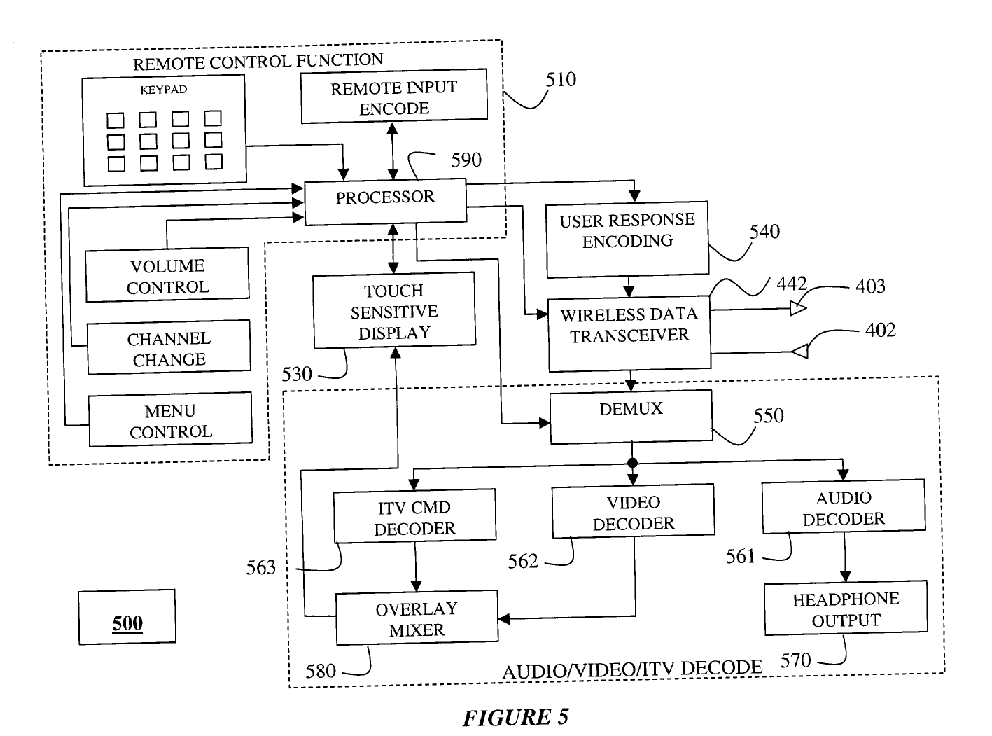

FIG. 5 shows the RCU 500 according to the invention. In addition to the traditional RCU functions 510, the RCU is equipped with a touch-sensitive display 530, a wireless transceiver 442 based on the technology such as Bluetooth, a demultiplexer 550, an audio decoder 561, a video decoder 562, an ITV command decoder 563, an audio output port 570, such as head phone plug, a graphics overlay mixer 580, and a processor 590.

The RCU 500 receives encoded visual, audio, and ITV data via the wireless data transceivers 441-442 transcoded as the secondary TV signal 402. The demultiplexer 550 de-multiplexes and passes the encoded data of the secondary TV signal to the appropriate decoders 561-563. Depending on the configuration of the system and the capabilities of the digital AV receiver 600 and the RCU 500, the RCU can just receive transcoded video with instructions to capture the user interaction in the form of the display coordinates.

The overlay mixer 580 mixes the decoded secondary TV signal, and any text or graphics produced by the ITV decoder 563. The output of the overlay mixer 580 is displayed on the touch sensitive display 530 concurrent with the display of the primary TV signal. If audio data are present in the received data, the audio decoder 561 decodes that data and outputs the audio signal to the headphone output 570. Any user interaction is appropriately encoded by the user response encoding function 540 and communicated to the digital AV receiver 600 over the wireless connection 403.

In one embodiment of the invention, the secondary TV signal 402 received by the RCU 500 is in the MPEG-4 “simple profile” format, the audio uses a low bit rate advanced audio coding (AAC), and the ITV commands are in MPEG-4 systems binary format for scenes (BIFS) format. ITV commands can include instructions to report coordinates of the point on the display with which the user interacts by touching the screen 530.

AV Receiver

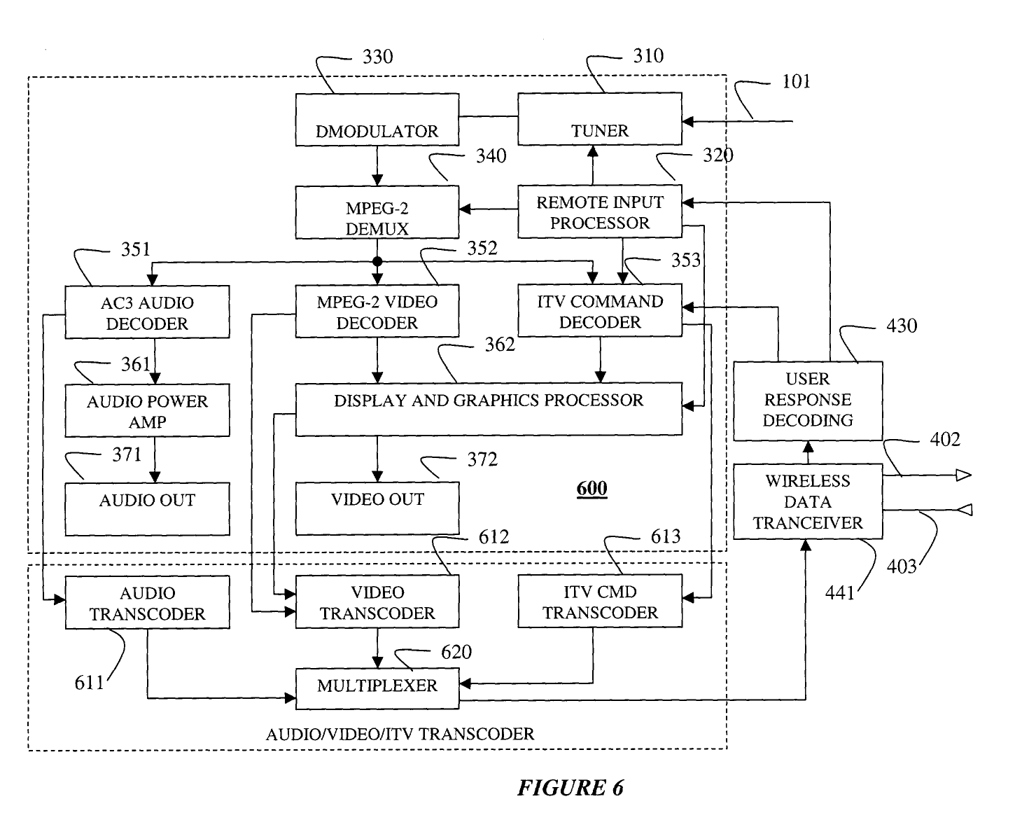

FIG. 6 shows the AV receiver 600 to support the remote control user interface according to the invention. In addition to the traditional digital AV receiver functions, the AV receiver is equipped with an audio transcoder 611, video transcoder 612, an ITV transcoder 613, a multiplexer 620, the wireless transceiver 441, and the user response decoding function 430.

The transcoders 611-613 receive input from the corresponding decoders 351-353. The audio decoder receives the decoded data and the audio transcoder re-encodes the decoded audio at, e.g., a lower bit rate.

The video transcoder receives a partially decoded bitstream and transcodes the video bitstream into a video with different format, e.g., a lower spatial resolution, lower temporal rate and/or lower bit-rate. See for example, “Architectures for MPEG compressed bitstream scaling,” IEEE Transactions on Circuits and Systems for Video Technology, April 1996 by Sun et al. for rate reduction, and U.S. patent application Ser. No. 09/853,394, “Video Transcoder with Spatial Resolution Reduction,” filed on May 11, 2001 by Vetro et al., incorporated herein by reference.

The ITV application uses the MPEG-4 Systems BIFS format and is transcoded appropriately to a smaller subset of the BIFS. The transcoded data are multiplexed 620 and communicated to the RCU 500 via the wireless data transceivers. The AV receiver, by means of the wireless data transceivers receives the user response entered on the RCU 500. The user response decoding function 430 processes the user responses received from the RCU 500 and forwards the response to the remote input processor 320 to act on the RCU functions, or to the ITV command decoder 353 to act on the user response to the interactive application.

The transcoded secondary content delivered to the RCU does not have to include all the three components audio, video, and ITV application. In the simplest form, using only video, the video along with the overlaid graphics are encoded into MPEG-4 video format and the ITV commands are set to receive the coordinates of the point the user interacts with (taps) on the RCU touch sensitive display. The user response decoding function and the ITV command decoder on the digital AV receiver translate the interaction point into an interactive event if the point lies on any of the interactive elements displayed on the television.

Applications

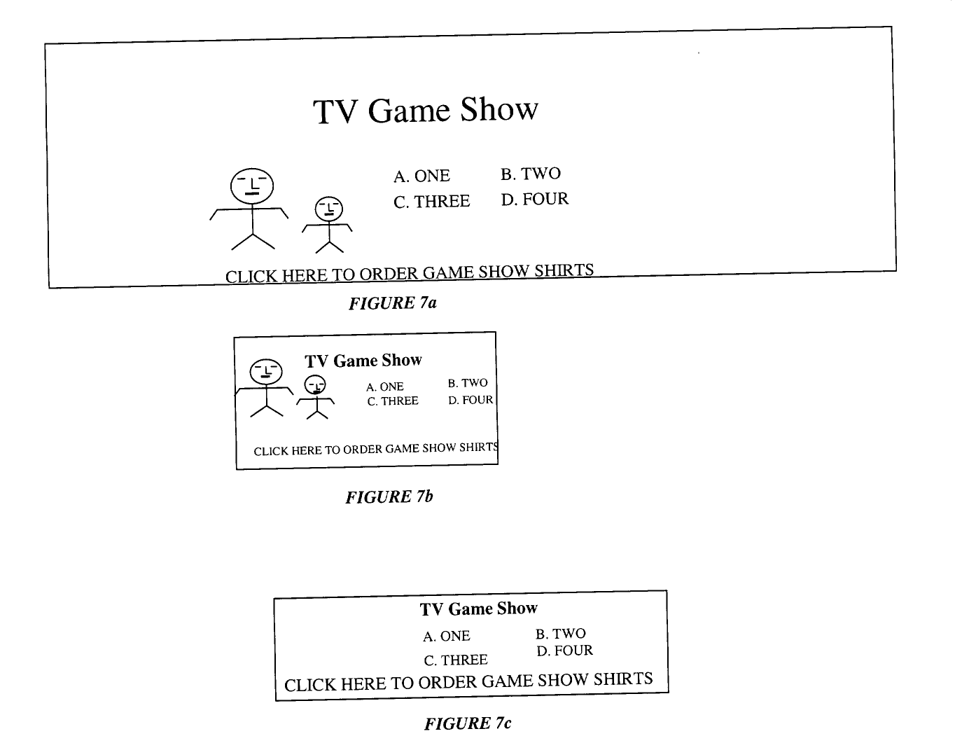

FIG. 7a-c depict an example application scenario making use of the invention. FIG. 7a shows the example, as seen on television, of a television game show with interactive TV application for users to play along with the game show. The users can select one of the answers A, B, C, or D and can also select a link to purchase a T-shirt with the game show logo.

With the RCU 500 according to the invention, the transcoded game show application can be transmitted and then displayed on the RCU 500. FIG. 7(b) shows a reduced scale video and application displayed on the RCU. The digital AV receiver can transcode the content into the reduced scale application in one of the two ways.

The video output of the graphics and overlay mixer is encoded into the MPEG-4 video format by the video transcoder and the ITV application component is not used. In this case, the RCU does not use its ITV decoder to process user response and just retransmits the coordinates of the interaction points back to the receiver.

Alternatively, video and ITV application are transcoded separately and composed after the decoding process on the RCU. In this case the RCU can process the user response and communicate back the complete user response to the receiver. The visual displayed on the RCU is the same in both cases.

FIG. 7c shows the content as seen on the RCU display. The composed visual on the RCU does not contain the scaled down video. In this case, the video and audio are not transcoded by the digital AV receiver; just the interactive elements of the content are transcoded and communicated to the RCU. The ITV decoder on the RCU decodes the ITV commands and renders the text and graphics on the RCU display.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. An audio-visual system, comprising:
a receiver configured to receive and display a primary television signal having a first format;
means for transcoding the primary television signal in the first format to a secondary television signal having a second format; and
a remote control unit, for controlling the receiver, configured to receive and display the secondary television signal concurrent with the display of the primary television signal.

2. The audio-visual system of claim 1 further comprising:
a wireless radio frequency link connecting the receiver and the remote control unit.

3. The audio-visual system of claim 1 wherein the means for transcoding further comprises:
an encoder in the receiver; and
a decoder in the remote control unit.

4. The audio-visual system of claim 1 wherein the remote control unit further comprises:
a touch-sensitive screen.

5. The audio-visual system of claim 4 wherein user input is entered using the touch-sensitive screen.

6. The audio-visual system of claim 4 wherein the remote control unit further comprises:
means for encoding the user input.

7. The audio-visual system of claim 1 wherein the primary television signal includes an audio signal, a video signal and an interactive TV signal.

8. The audio-visual system of claim 7 wherein the remote control unit further comprises an overlay mixer for combining the video signal and the interactive TV signal.

9. The audio-visual system of claim 7 wherein the primary and secondary television signals employ MPEG-4 encoding.

10. The audio-visual system of claim 1 wherein the receiver further comprises:
an audio decoder and a video decoder;
an audio transcoder and a video transcoder coupled respectively to the decoders; and
a multiplexer combining outputs of the transcoders to generate the secondary television signal.

11. A method for operating an audio-visual system, comprising:
receiving and displaying a primary television signal having a first format in a receiver;
transcoding the primary television signal in the first format to a secondary television signal having a second format; and
receiving and displaying the secondary television signal in a remote control unit for the receiver.
